(19) United States
(12) Patent Application Publication
(10) Pub. No.: US 2024/0282120 A1
(43) Pub. Date: Aug. 22, 2024

(54) INFORMATION PROCESSING APPARATUS, INFORMATION PROCESSING METHOD, AND STORAGE MEDIUM

(71) Applicant: HONDA MOTOR CO., LTD., Tokyo (JP)

(72) Inventors: Takeshi KIBAYASHI, Tokyo (JP); Toshiyuki KAJI, Tokyo (JP); Fumito NISHI, Tokyo (JP)

(21) Appl. No.: 18/432,791

(22) Filed: Feb. 5, 2024

(30) Foreign Application Priority Data
Feb. 22, 2023 (JP) 2023-026372

(51) Int. Cl. G06V 20/58; G06T 7/10; G06V 10/60

(52) U.S. Cl. CPC G06V 20/584; G06T 7/10; G06V 10/60

(57) ABSTRACT

An obtaining unit obtains a first image in which an advancing direction of a vehicle is captured and a second image in which the advancing direction of the vehicle is captured at a time different from a time when the first image is captured. A setting unit sets a partial area including a light source provided in a preceding vehicle that precedes the vehicle in an image in which the advancing direction of the vehicle is captured, based on the first image and the second image. An evaluating unit evaluates periodicity of light emission of the light source, based on the partial areas in a plurality of images in which the advancing direction of the vehicle is captured. An identifying unit identifies a type of the light source, based on the periodicity.

### CROSS-REFERENCE TO RELATED APPLICATION(S)

This application claims priority to and the benefit of Japanese Patent Application No. 2023-026372 filed on Feb. 22, 2023, the entire disclosure of which is incorporated herein by reference.

### BACKGROUND OF THE INVENTION

### Field of the Invention

The present invention relates to an information processing apparatus, an information processing method, and a storage medium.

### Description of the Related Art

A technology has been conventionally present for identifying an object such as a preceding vehicle or an obstacle, based on an imaging result of an environment outside a vehicle, and controlling the vehicle from an identification result. For example, Japanese Patent Laid-Open No. 2013-109391 discloses a technique for associating a position of a light-emitting source with a preceding vehicle in an image, based on an image captured with an exposure time corresponding to brightness in the environment outside the vehicle and an image captured with an exposure time with which it is possible to determine whether the light-emitting source in the image is emitting light by itself.

### SUMMARY OF THE INVENTION

According to one embodiment of the present disclosure, an information processing apparatus comprises: an obtaining unit configured to obtain a first image in which an advancing direction of a vehicle is captured and a second image in which the advancing direction of the vehicle is captured at a time different from a time when the first image is captured; a setting unit configured to set a partial area including a light source provided in a preceding vehicle that precedes the vehicle in an image in which the advancing direction of the vehicle is captured, based on the first image and the second image; an evaluating unit configured to evaluate periodicity of light emission of the light source, based on the partial areas in a plurality of images in which the advancing direction of the vehicle is captured; and an identifying unit configured to identify a type of the light source, based on the periodicity.

According to another embodiment of the present disclosure, an information processing method comprises: obtaining a first image in which an advancing direction of a vehicle is captured and a second image in which the advancing direction of the vehicle is captured at a time different from a time when the first image is captured; setting a partial area including a light source provided in a preceding vehicle that precedes the vehicle in an image in which the advancing direction of the vehicle is captured, based on the first image and the second image; evaluating periodicity of light emission of the light source, based on the partial areas in a plurality of images in which the advancing direction of the vehicle is captured; and identifying a type of the light source, based on the periodicity.

According to yet another embodiment of the present disclosure, a non-transitory computer-readable storage medium storing a program that, when executed by a computer, causes the computer to perform an information processing method comprises: obtaining a first image in which an advancing direction of a vehicle is captured and a second image in which the advancing direction of the vehicle is captured at a time different from a time when the first image is captured; setting a partial area including a light source provided in a preceding vehicle that precedes the vehicle in an image in which the advancing direction of the vehicle is captured, based on the first image and the second image; evaluating periodicity of light emission of the light source, based on the partial areas in a plurality of images in which the advancing direction of the vehicle is captured; and identifying a type of the light source, based on the periodicity.

### BRIEF DESCRIPTION OF THE DRAWINGS

FIG. 1 is a diagram illustrating an example of a system according to an embodiment of the present invention;

FIG. 2 is a view illustrating an example of an image in which a back surface of a vehicle is captured;

FIG. 3 is a diagram illustrating an example of a configuration of the vehicle;

FIG. 4 is a block diagram illustrating an example of a functional configuration of an information processing apparatus according to the present embodiment;

FIG. 5 is a diagram for describing a partial area according to the present embodiment;

FIG. 6 is a flowchart illustrating an example of processing by the information processing apparatus according to the present embodiment; and

FIG. 7 is a diagram for describing another example of the partial area according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the technique described in Japanese Patent Laid-Open No. 2013-109391, it is difficult to set an exposure time with which it is possible to determine whether the light-emitting source is emitting light by itself, in some cases. In addition, in order to alternately obtain images on different exposure times, it is necessary to prepare a dedicated camera that is not a general-purpose one, in some cases.

Therefore, according to an embodiment of the present invention, it becomes possible to more easily determine a light of a preceding vehicle in an image.

An information processing apparatus according to an embodiment of the present invention obtains a first image in which an advancing direction of a vehicle is captured and a second image in which the advancing direction of the vehicle is captured at a time different from the time when the first image is captured. In addition, the information processing apparatus sets a partial area including a light source provided in a preceding vehicle in an image in which the advancing direction of the vehicle is captured, based on the first image and the second image. Furthermore, the information processing apparatus evaluates periodicity of light emission of the light source, based on partial areas in a plurality of images in which the advancing direction of the vehicle is captured, and identifies the type of the light source, based on the evaluated periodicity. In the present embodiment, the information processing apparatus is an electronic control unit (ECU) mounted on a vehicle, and is capable of controlling the vehicle in accordance with each processing result. However, as long as similar operations are available, the information processing apparatus may be an apparatus separate from the vehicle, such as, for example, a server, without being limited thereto.

### [System]

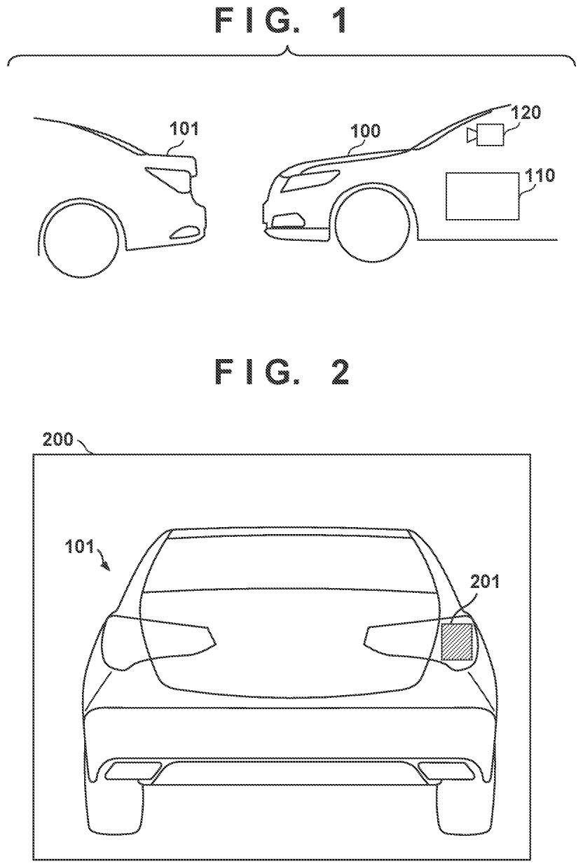

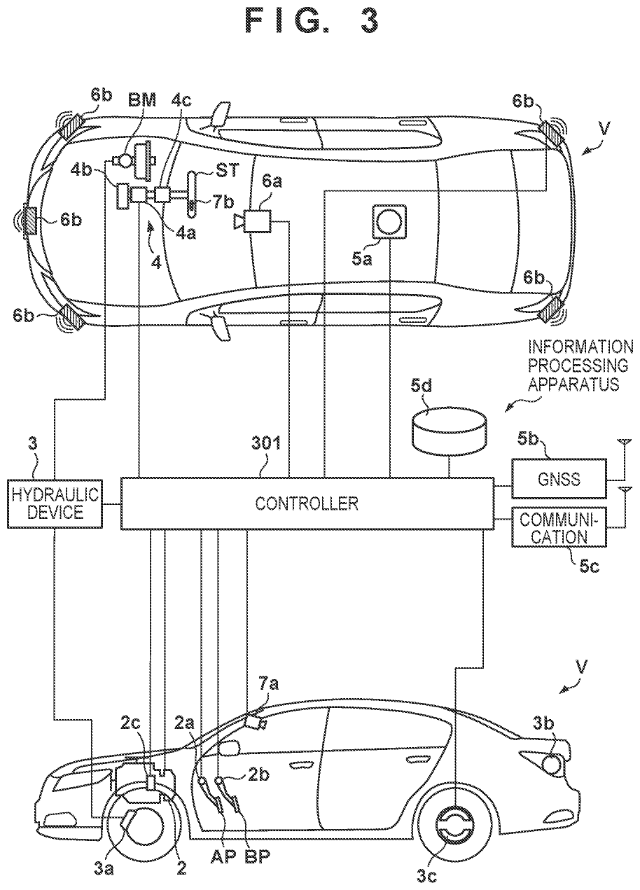

Hereinafter, a vehicle control system (hereinafter, also simply referred to as a “system”) according to a vehicle 100 including an information processing apparatus 110 according to the present embodiment will be described with reference to FIG. 1. FIG. 1 is a diagram illustrating a configuration of an information processing system in which a vehicle control system according to the present embodiment is provided by the information processing apparatus 110. The information processing apparatus 110 according to the present embodiment is an on-vehicle apparatus of the vehicle 100. In the example of FIG. 1, it is assumed that the vehicle 100 performs automated driving using a driving assistance technology with a configuration as illustrated in FIG. 2, and automatically follows a vehicle 101, which is a preceding vehicle.

In the system illustrated in FIG. 1, the information processing apparatus 110 obtains an image in which an advancing direction of the vehicle 100 is captured. Here, an imaging device 120 included in the vehicle 100 images the advancing direction of the vehicle, and the information processing apparatus 110 is capable of acquiring an imaging result. In the example of FIG. 1, the vehicle 101, which is a preceding vehicle that precedes the vehicle 100, is present, and the imaging device 120 images a forward side (the advancing direction) of the vehicle 101 to image the back surface (a surface on an opposite side of its advancing direction) of the vehicle 100. The imaging device 120 according to the present embodiment is assumed to be an identical imaging device to a surroundings detection unit 6a in FIG. 3 to be described later. However, the vehicle 100 may include a separate imaging device as the imaging device 120. In addition, in the following description, the information processing apparatus 110 and the imaging device 120 will be described as separate apparatuses. However, as in a case where the information processing apparatus 110 is built in the imaging device 120, some or all of the functions to be described as being performed by the information processing apparatus 110 may be configured to be performed by the imaging device 120.

FIG. 2 is an example of an image of the back surface of vehicle 101 that has been captured by the imaging device 120. In an image 200, a blinker 201 on the right side in the advancing direction, which is one of lights on the back surface of the vehicle 101, is turned on. In the following, images by the imaging device 120 according to the present embodiment will be described to be represented by RGB. However, any other model such as CMYK may be used, as long as similar processing and evaluation are available.

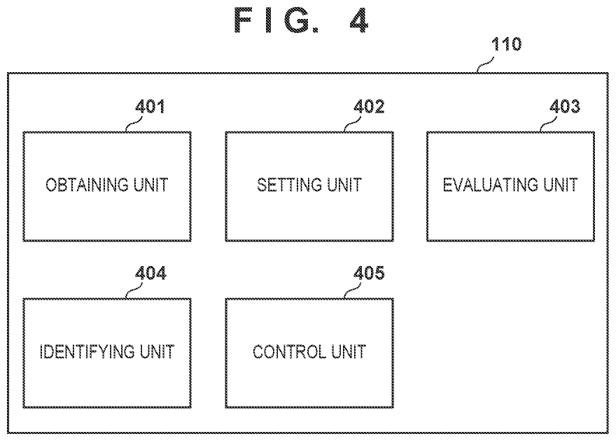

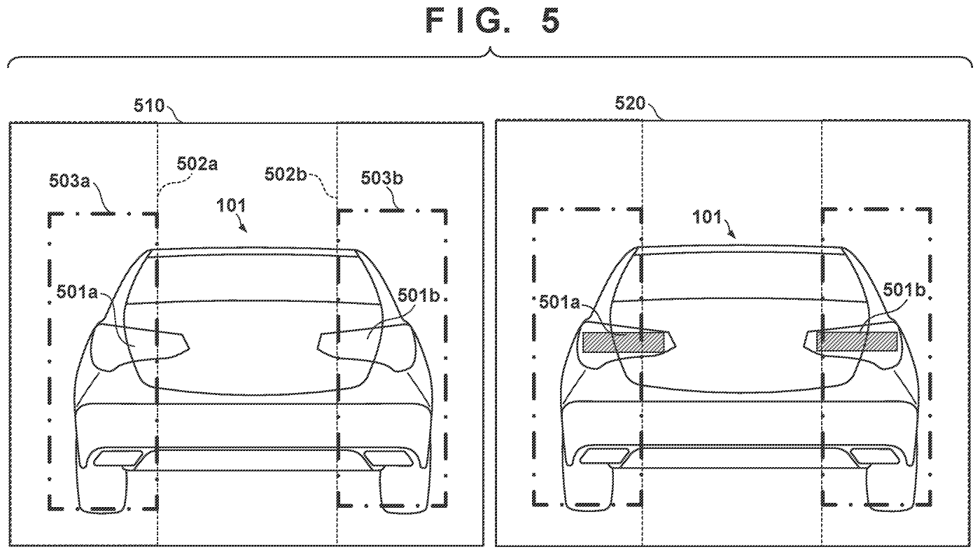

The information processing apparatus 110 performs various types of processing to be described later, based on an image obtained from the imaging device 120, and identifies the type of a light source provided in the vehicle 101 in the image. The processing by the information processing apparatus 110 will be described later with reference to FIGS. 4 and 5. Here, the information processing apparatus 110 may perform, for example, driving assistance of the vehicle 100, based on an identified type of the light source, and may adjust an inter-vehicle distance to the vehicle 101. An example of the control in the driving assistance will be described with reference to FIG. 2.

### [Configuration of Vehicle 100]

FIG. 3 is a block diagram illustrating an example of a configuration of the vehicle 100 including the information processing apparatus 110 according to the present embodiment. In FIG. 1, the vehicle 100 is schematically illustrated in a plan view and a side view. The vehicle 100 in the present embodiment is, for example, a sedan-type four-wheeled passenger vehicle, and can be, for example, a parallel hybrid vehicle. Note that the vehicle 100 is not limited to a four-wheeled vehicle, and may be a straddle type vehicle (a two-wheel motorcycle, a three-wheel motorcycle) or a large-sized vehicle such as a truck or a bus.

The information processing apparatus 110 includes a controller 301, which is an electronic circuit that conducts control of the vehicle 100, including the driving assistance of the vehicle 100. The controller 301 includes a plurality of ECUs. The ECU is provided for every function of the information processing apparatus 110, for example. Each ECU includes a processor represented by a central processing unit (CPU), a storage device such as a semiconductor memory, an interface with an external apparatus, and the like. The storage device stores a program to be executed by the processor, data used for processing by the processor, and the like. The interface includes an input and output interface, and a communication interface. Each ECU may include a plurality of processors, a plurality of storage devices, and a plurality of interfaces.

The controller 301 controls driving (acceleration) of the vehicle 100 by controlling a power unit (a power plant) 2. The power unit 2 is a travel driving unit that outputs driving force for rotating driving wheels of the vehicle 100, and can include an internal combustion engine, a motor, and an automatic transmission. The motor can be used as a drive source for accelerating the vehicle 100, and can also be used as a generator at the time of deceleration or the like (regenerative braking).

In a case of the present embodiment, the controller 301 controls the output of the internal combustion engine or the motor, or switches a gear ratio of the automatic transmission in accordance with the driver's driving operation, the vehicle speed, or the like that has been detected by an operation detection sensor 2a, which is provided on an accelerator pedal AP, or an operation detection sensor 2b, which is provided on a brake pedal BP. Note that in the automatic transmission, a rotation speed sensor 2c that detects a rotation speed of an output shaft of the automatic transmission is provided as a sensor that detects a traveling state of the vehicle 100. The vehicle speed of the vehicle 100 can be arithmetically operated from a detection result of the rotation speed sensor 2c.

By controlling a hydraulic device 3, the controller 301 controls braking (deceleration) of the vehicle 100. The driver's braking operation on the brake pedal BP is converted into hydraulic pressure in a brake master cylinder BM, and is transmitted to the hydraulic device 3. The hydraulic device 3 is an actuator capable of controlling the hydraulic pressure of the hydraulic oil supplied to a brake device 3a (for example, a disc brake device) provided on each of the four wheels, based on the hydraulic pressure transmitted from the brake master cylinder BM.

By conducting drive control of an electromagnetic valve or the like included in the hydraulic device 3, the controller 301 is capable of controlling braking of the vehicle 100. In addition, by controlling the distribution of the braking force by the brake device 3a and the braking force by the regenerative braking of the motor included in the power unit 2, the controller 301 can also configure an electric servo brake system. The controller 301 may turn on a brake lamp 3b at the time of braking.

By controlling an electric power steering device 4, the controller 301 controls the steering of the vehicle 100. The electric power steering device 4 includes a mechanism that steers the front wheels in accordance with a driver's driving operation (a steering operation) on a steering wheel ST. The electric power steering device 4 includes a drive unit 4a including a motor that exerts driving force (referred to as steering assist torque, in some cases) for assisting the steering operation or automatically steering the front wheels, a steering angle sensor 4b, a torque sensor 4c that detects steering torque (referred to as steering load torque to be distinguished from the steering assist torque) applied by the driver, and the like.

The controller 301 controls an electric parking brake device 3c provided on the rear wheel. The electric parking brake device 3c includes a mechanism for locking the rear wheels. The controller 301 is capable of controlling locking and unlocking of the rear wheels by use of the electric parking brake device 3c.

The controller 301 controls an information output device 5 that notifies information to the inside of the vehicle. The information output device 5 includes, for example, a display device 5a that notifies the driver of information by an image and/or a voice output device 5b that notifies the driver of information by sound. The display device 5a can be provided on, for example, an instrument panel or a steering wheel ST. The display device 5a may be a head-up display. The information output device 5 may notify the occupant of information by vibration or light. In addition, the controller 301 receives an instruction input from an occupant (for example, a driver) via an input device 6. The input device 6 is disposed in a position operable by the driver, and includes, for example, a switch group 6a with which the driver gives an instruction to the vehicle 100 and/or a blinker lever 6b that actuates a direction indicator (a blinker).

The controller 301 recognizes and determines a current position and a course (an attitude) of the vehicle 100. In a case of the present embodiment, in the vehicle 100, a gyro sensor 5a, a global navigation satellite system (GNSS) sensor 5b, and a communication device 5c are provided. The gyro sensor 5a detects rotational motion (a yaw rate) of the vehicle 100. The GNSS sensor 5b detects the current position of the vehicle 100. In addition, the communication device 5c performs wireless communication with a server that provides map information and traffic information, and obtains these pieces of information. In a case of the present embodiment, the controller 301 determines a course of the vehicle 100, based on detection results of the gyro sensor 5a and the GNSS sensor 5b, sequentially obtains highly-accurate map information about the course from the server via the communication device 5c, and stores the map information in a database 5d (a storage device). Note that in the vehicle 100, a sensor that detects a state of the vehicle 100, such as a speed sensor that detects the speed of the vehicle 100 or an acceleration sensor that detects the acceleration of the vehicle 100, may be provided.

The controller 301 performs the driving assistance for the vehicle 100, based on detection results of various detection units provided in the vehicle 100. In the vehicle 100, surroundings detection units 6a and 6b, which are external sensors that detect the outside (a surrounding situation) of the vehicle 100, and in-vehicle detection units 7a and 7b, which are in-vehicle sensors that detect situations inside the vehicle (a state of the driver). The controller 301 is capable of grasping the surrounding situation of the vehicle 100, based on the detection results of the surroundings detection units 6a and 6b, and performing the driving assistance in accordance with the surrounding situation. In addition, the controller 301 is capable of determining whether the driver is performing a predetermined operation duty imposed on the driver in performing the driving assistance, based on the detection results of the in-vehicle detection units 7a and 7b.

The surroundings detection unit 6a is an imaging device that captures an image of a forward side of the vehicle 100, and is attached to a vehicle interior side of the windshield in a roof front part of the vehicle 100, for example. By analyzing the image captured by the surroundings detection unit 6a, the controller 301 is capable of extracting a contour of a target object or a lane marking (such as a white line) on a road.

The surroundings detection unit 6a according to the present embodiment may be an imaging device separate from the imaging device 120, or may capture an image of the back surface of the vehicle 101, as the imaging device 120.

The surroundings detection unit 6b is a millimeter wave radar (hereinafter, referred to as the radar 6b in some cases), detects a target object in the surroundings of the vehicle 100 by using radio waves, and detects (measures) a distance to the target object and a direction (an azimuth) of the target object with respect to the vehicle 100. In the example illustrated in FIG. 1, five radars 6b are provided. One is provided at the center of the front part of the vehicle 100, another one is provided at each of the left and right corner portions of the front part, and the other one is provided at each of the left and right corner portions of a rear part.

Note that the surroundings detection unit provided in the vehicle 100 is not limited to the above configuration. The number of cameras and the number of radars may be changed, or a light detection and ranging (LiDAR) for detecting a target object in the surroundings of the vehicle 100 may be provided.

The in-vehicle detection unit 7a is an imaging device that captures an image of the inside of the vehicle (hereinafter, referred to as an in-vehicle camera 7a, in some cases), and is attached to the vehicle interior side in the roof front part of the vehicle 100, for example. In a case of the present embodiment, the in-vehicle camera 7a is a driver monitor camera that captures an image of the driver (for example, the driver's eyes and face). By analyzing an image (a face image of the driver) that has been captured by the in-vehicle camera 7a, the controller 301 is capable of determining a driver's line of sight and an orientation of the driver's face.

The in-vehicle detection unit 7b is a grip sensor that detects the driver's grip on the steering wheel ST (hereinafter, referred to as the grip sensor 7b, in some cases), and is provided in at least a part of the steering wheel ST, for example. As the in-vehicle detection unit, the torque sensor 4c that detects the steering torque of the driver may be used.

Examples of the driving assistance of the vehicle 100 include acceleration and deceleration assistance, lane keeping assistance, and lane change assistance. The acceleration and deceleration assistance is driving assistance (adaptive cruise control (ACC)) that controls acceleration and deceleration of the vehicle 100 within a predetermined vehicle speed while maintaining an inter-vehicle distance to a preceding vehicle, by controlling the power unit 2 and the hydraulic device 3. The lane keeping assistance is a driving assistance system (lane keeping assist system (LKAS)) that controls the electric power steering device 4 to keep the vehicle 100 inside the lane. The lane change assistance is driving assistance (auto lane changing (ALC), active lane change assist (ALCA)) for changing the traveling lane of the vehicle 100 to an adjacent lane, by controlling the electric power steering device 4. In addition, the driving assistance performed by the controller 301 may include collision reduction brake that assists avoiding a collision with a target object (for example, a pedestrian, another vehicle, or an obstacle) on a road, ABS function, traction control, and/or attitude control of the vehicle 100, by controlling the hydraulic device 3.

### [Functional Configuration of Information Processing Apparatus 110]

Next, information processing performed by the information processing apparatus 110 according to the present embodiment will be described with reference to FIG. 4. FIG. 4 is a block diagram illustrating an example of a functional configuration of the information processing apparatus 110. The information processing apparatus 110 includes an obtaining unit 401, a setting unit 402, an evaluating unit 403, an identifying unit 404, and a control unit 405.

The obtaining unit 401 obtains an image in which the advancing direction of the vehicle 100 is captured. The obtaining unit 401 according to the present embodiment obtains an image that has been captured by the imaging device 120. However, for example, the information processing apparatus 110 may have an imaging function to capture an image of the advancing direction of the vehicle 100. Hereinafter, a term “captured image” will simply refer to an image in which the advancing direction of the vehicle 100 is captured. The obtaining unit 401 according to the present embodiment obtains a first captured image and a second captured image that is captured at a different time from the time when the first captured image is captured. A time difference in capturing images between the first captured image and the second captured image can be set, based on periodicity of light emission of (an assumed type of) a light source provided in the preceding vehicle. For example, the user is able to optionally set such a time difference as a period of time while it is possible to capture a change due to the light source turning on (for example, the blinker) that is provided in the vehicle 101, in the captured image. The time difference in capturing images between the first captured image and the second captured image can be, for example, 0.5 seconds, in a case where an assumed blinking cycle of the blinker is 60 times per minute.

The setting unit 402 sets a partial area including the light source provided in the preceding vehicle that precedes the vehicle 100 in an image in which the advancing direction of the vehicle 100 is captured, based on the first captured image and the second captured image. For example, the setting unit 402 according to the present embodiment is capable of estimating the position of the light source in the captured image, based on a difference between the first captured image and the second captured image, and setting a partial area including the estimated light source.

Here, an example of processing, by the setting unit 402, for estimating the position of the light source in the captured image will be described. In a case where a lamp (a light source) provided in the preceding vehicle is turned on in a captured image, it is conceivable that luminance (or brightness) at a position of such a light source becomes equal to or higher than a predetermined value. From such a viewpoint, the setting unit 402 may estimate an area in the captured image in which the luminance value is equal to or higher than a preset predetermined threshold to be the area indicating the position of the light source in the captured image. Such a threshold value can be set to a desired value in accordance with exposure settings, environmental conditions, and the like in the imaging device 120, but may be 150, for example. Note that this processing can be performed by any technology, as long as the position of the light source in the captured image can be estimated. For example, an area where each of the RGB values is present within a predetermined range (for example, R is equal to or higher than 200, and G and B are each equal to or higher than 50) may be estimated to be the position of the light source.

In addition, in a case where the light source blinks between the first captured image and the second captured image, it is conceivable that a pixel value at the position of the light source is equal to or higher than a predetermined value in the difference between the first captured image and the second captured image. In order to estimate the position of the light source, based on such a viewpoint, the setting unit 402 may use the difference between the first captured image and the second captured image. For example, in the area where the pixel value is equal to or higher than the predetermined value in the difference between the first captured image and the second captured image, the setting unit 402 is capable of estimating an area that overlaps an area of a pixel value considered to have a possibility of the light source in the first captured image and/or the second captured image to be the position of the light source in the captured image. Here, in a case where the pixel value falls within a specific range, for example, a range estimated to be red (for example, R is equal to or higher than 200, and G and B are each equal to or lower than 50) or a range estimated to be yellow (for example, R and G are equal to or higher than 200, and B is equal to or lower than 50), the setting unit 402 is capable of setting an area having such pixel values to the area having a possibility of the light source.

As described above, the setting unit 402 sets the partial area including the light source, the position of which has been estimated, in the captured image. In the present embodiment, the setting unit 402 is configured to set a rectangular area including the light source on the captured image, as the above-described partial area. Here, the setting unit 402 may set a rectangular partial area just including the light source, or may set a rectangular partial area including the light source with a margin of a predetermined width (for example, 20 pixels). In addition, for example, in order to prevent detection omission, a vertical width of such a rectangle may be set in accordance with a vertical width of the vehicle that has been detected from the captured image (for example, to be the same as the vertical width of the vehicle).

Note that here the light source provided in the vehicle 101 is some type of light, such as a blinker, a brake lamp, a high-mount stop lamp, or a tail lamp. It is conceivable that these light sources are arranged symmetrically in the vicinity of the left and right ends of the back surface of the vehicle 101. Therefore, the setting unit 402 may set the above-described partial areas in areas having predetermined widths from a left end and a right end of the captured image (hereinafter, referred to as “left-right areas”). For example, the setting unit 402 may set the areas each having a width of 200 pixels from the left end and the right end as the left-right areas in the captured image having 960×960 pixels, and may set the above-described partial areas in the left-right areas. This processing may be processing of estimating the position of the light source with reference to pixels in the left-right areas that have been set, or processing of estimating the position of the light source from the entirety of the captured image and limiting the partial areas to be set from the position to within the left-right areas. Note that here it is assumed that the respective lights are arranged on the left and right sides. However, it may also be assumed that the lights are arranged on a left-right line symmetrical axis on the back surface of the vehicle, and the partial areas may also be set in areas each having a predetermined width passing on such a line symmetrical axis, in addition to the left-right areas described above.

FIG. 5 is a diagram illustrating partial areas set in the left-right areas according to the present embodiment. In FIG. 5, in the first captured image 510 and the second captured image 520 by the imaging device 120, a back surface of the vehicle 101 including brake lamps 501a and 501b is captured. In the first captured image 510 and the second captured image 520, a left-right area 502a having a predetermined width (200 pixels in this case) from the left end and a left-right area 502b having a predetermined width from the right end are set. The brake lamps 501a and 501b are not turned on in the first captured image 510, and the brake lamps 501a and 501b are turned on in the second captured image. Therefore, in the example of FIG. 5, a partial area 503a is set in the left-right area 502a, and a partial area 503b is set in the left-right area 502b, based on a difference between the first captured image 510 and the second captured image 520.

The evaluating unit 403 evaluates periodicity of the light emission of the light source, based on the partial areas in the plurality of captured images. Here, the evaluating unit 403 is capable of evaluating whether the light source present in the partial area is blinking at a predetermined cycle or it is turned on without blinking at the predetermined cycle. The identifying unit 404 identifies the type of the light source present in the partial area, based on such evaluation of the periodicity. Here, for example, the identifying unit 404 may identify a light source that has been evaluated to be blinking at the predetermined cycle as a blinker, and a light source that has been evaluated not to be blinking at the predetermined cycle as a light source that is not a blinker (for example, a brake lamp). Note that the plurality of captured images used here may include the first captured image and the second captured image used for setting the partial areas, or does not have to include them.

The evaluating unit 403 according to the present embodiment evaluates the periodicity of the light emission of the light source included in the partial area, based on a pixel value of the partial area for each of the captured images. For example, the evaluating unit 403 may calculate an average of luminance in the partial area and evaluate the periodicity based on a history of calculated average values, or may calculate an average for each of RGB of pixels in the partial area, generate a frequency domain from the history of the calculated average values, and evaluate the periodicity. Hereinafter, the average of the luminance or the pixel value in the partial area in one captured image that has been calculated in this manner to be used for evaluating the periodicity will be simply expressed as a “partial average”, in some cases.

The blinker according to the present embodiment is a light that indicates its direction to the surroundings by blinking when the vehicle turns to the left or right or changes its course. Here, it is assumed that the blinker blinks at a cycle equal to or larger than 60 times and equal to or smaller than 120 times per minute. In a case where an evaluation result of the periodicity falls within such a range, the identifying unit 404 identifies that the light source is the blinker. In this manner, the identifying unit 404 according to the present embodiment identifies the type of the light source in accordance with the evaluation result of the periodicity of the light emission of the light source. Therefore, the obtaining unit 401 is capable of obtaining a plurality of captured images by the imaging device 120 (for example, each frame in a predetermined period of time at a constant cycle such as once every 0.5 seconds).

The evaluating unit 403 according to the present embodiment is capable of accumulating the history of partial averages in the captured images that have been captured during a predetermined period of time, and evaluating the periodicity from values of the partial luminance averages that have been accumulated. For example, the evaluating unit 403 is capable of evaluating the periodicity of the light emission of the light source depending on whether the periodicity of the light emission corresponding to a certain type of light source is detected, in the partial averages in the captured images that have been captured during the predetermined period of time. In addition, for example, the evaluating unit 403 may convert data of the partial average in the captured images that have been captured during the predetermined period of time into a frequency domain in accordance with Fourier transform, and may extract a periodic change in color. These types of processing are not particularly limited, as long as the presence or absence of the above-described periodic blinking of the light source can be evaluated. Any other known method capable of detecting the blinking of the light source in the image may be used.

Note that the identifying unit 404 is capable of determining whether the light source is turned on (without blinking), based on a pixel value (or luminance) of the partial area, for the light source that has been evaluated not to be blinking at a predetermined cycle. This means that, for example, in a case where the average pixel value of the partial area maintains a pixel value within a predetermined range that has been set beforehand to be supposed that the light source is turned on for a predetermined period of time (for example, two seconds), the light source may be determined to be turned on. In addition, for example, the identifying unit 404 may determine whether the light source is turned on without blinking, based on the history of the partial averages for a predetermined period of time. This processing can be performed by processing similar to common light source detection processing, and thus its detailed description will be omitted.

The control unit 405 may control the driving assistance of the vehicle 100 in accordance with the type of the light source that has been identified by the identifying unit 404. For example, in a case where a light source that is a brake lamp is identified by the identifying unit 404, the control unit 405 is capable of decelerating the vehicle 100 by using the acceleration and deceleration assistance in order to maintain an inter-vehicle distance to the preceding vehicle 101. Further, for example, in a case where a light source that is a blinker is identified by the identifying unit 404, the control unit 405 is capable of controlling the advancing direction of the vehicle 100 to a direction indicated by the blinker that is blinking to assist traveling to follow the vehicle 101.

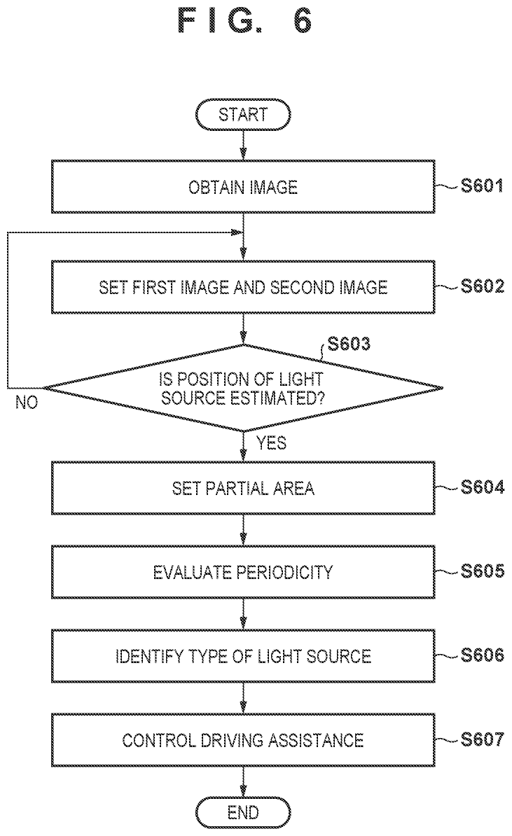

FIG. 6 is a flowchart illustrating an example of identification processing, by the information processing apparatus 110, for identifying the type of the light source in the image according to the present embodiment. The processing according to FIG. 6 will be described assuming that the processing starts from S601, when the driving assistance in the vehicle 100 is started.

In S601, the obtaining unit 401 obtains a plurality of captured images in which the advancing direction of the vehicle is captured. Here, it is assumed that the obtaining unit 401 obtains a captured image of each frame captured by the imaging device 120. In S602, the setting unit 402 sets a first captured image and a second captured image to be used for setting the partial areas in the captured images obtained in S601. Here, the setting unit 402 sets a captured image of a certain frame as the first captured image, and sets a captured image captured with a time difference of a predetermined period of time from the first captured image, as the second captured image. Note that here processing is performed separately in S601 for obtaining the captured images and in S602 for setting the captured images to be used for setting the partial areas. However, only the captured images to be used for setting the partial areas may be obtained in S601.

In S603, the setting unit 402 estimates the position of a light source in the captured image, based on the first captured image and the second captured image. Here, as described above, the setting unit 402 estimates the position of the light source, based on a difference between the first captured image and the second captured image. In a case where the position of the light source cannot be estimated, the processing returns to S602, and in a case where the position of the light source can be estimated, the processing proceeds to S604.

In S604, the setting unit 402 sets a partial area including the light source provided in the preceding vehicle (the vehicle 101) in the captured image, based on the position of the light source in the captured image estimated in S603. Here, the setting unit 402 sets the left-right areas in the captured images, and sets the partial areas to be included in the left-right areas.

In S605, the evaluating unit 403 evaluates the periodicity of the light emission of the light source, based on the partial areas set in S604 in the plurality of captured images. Here, the evaluating unit 403 uses the captured images for the predetermined period of time obtained in S601, and evaluates the periodicity of the light emission of the light source from the history of the averages of the pixel values of the partial areas in the respective captured images.

In S606, the identifying unit 404 identifies the type of the light source in the captured images, based on the periodicity evaluated in S605. In S607, the control unit 405 controls the driving assistance of the vehicle 100, based on the type of the light source identified in S606, and ends the processing of FIG. 6.

According to such processing, it becomes possible to set the partial area including the light source provided in the preceding vehicle in the captured images in which the advancing direction of the vehicle is captured and to evaluate the periodicity of the light emission of the light source, based on the partial areas in the plurality of captured images. In addition, the type of the light source can be identified, based on the evaluated periodicity. Therefore, by evaluating the periodicity of the light emission of the light source and identifying the type of the light source, it becomes possible to more easily determine the light of the preceding vehicle in the image.

Note that in the present embodiment, the areas having the predetermined width from the left and right ends of the captured image are respectively set as the left-right areas, and the partial areas are set to be included in the left-right areas. However, the setting processing of the partial areas is not particularly limited to the above description. For example, in consideration that the position of the light source that appears in the captured image would not be too close to an upper or lower end, the setting unit 402 may set the left-right areas to areas where a predetermined width is removed from the upper and lower ends from the left-right areas 502a and 502b illustrated in FIG. 5.

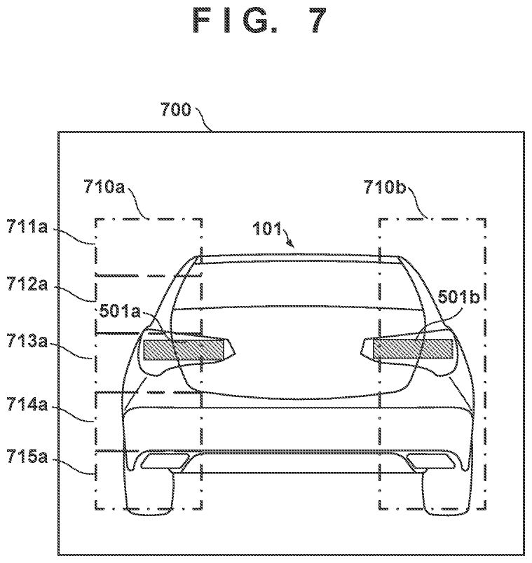

In addition, the description has been given assuming that the identifying unit 404 according to the present embodiment determines whether the light source is turned on (without blinking), based on the pixel values of the entire partial area, for the light source that has been evaluated not to be blinking at a predetermined cycle. However, it is not assumed that, for example, the brake lamp would be too close to a lower end on the back surface of the vehicle. Therefore, the identifying unit 404 may determine whether the light source is turned on by use of areas obtained by further dividing the partial area. For example, the identifying unit 404 may further divide the partial area into a plurality of divided areas, and determine whether the light source is turned on for only a part of the divided areas (for example, by use of only a divided area present on y-coordinate equal to or smaller than a predetermined value). Here, the coordinates are set such that coordinates on an upper left end are the origin (0, 0) and coordinates on a lower right end are (960, 960). FIG. 7 is a diagram for describing divided areas set in such a manner.

In an example of FIG. 7, partial areas 710a and 710b to be set similarly to the partial areas of FIG. 5 are set in a captured image 700. Hereinafter, only the partial area 710a on the left side will be described, but the same description is applied to the partial area 710b on the right side with regard to a condition without a difference between the left and the right in particular. Here, the partial area 710a is divided into five divided areas 711a to 715a, and the position of the brake lamp 501a corresponds to the divided area 713a. For example, by determining whether the light source is turned on only for 711a to 714a in these divided areas, the processing load can be reduced by further deleting the area to be processed.

Here, the identifying unit 404 may set the divided area having a largest variance (or center of gravity) of the average values of the luminance during a predetermined period of time to an area where the light source is turned on, or may set the divided area where such a variance is equal to or larger than a threshold to an area where the light source is turned on, or processing different from them may be performed. In addition, the description has been given assuming that the luminance is referred to here. However, in consideration that the amount of change in red would increase when the brake lamp is turned on, an R value may be used instead of the luminance, or a value obtained by performing a weighted sum of RGB such that the weight of the R value is larger than the luminance may be used.

Further, in the present embodiment, the description has been given assuming that the position of the light source is estimated, based on a difference between the captured images, and the partial area is set to include the estimated position of the light source. However, as long as the partial area includes the light source, it is not necessary to perform such processing. For example, the setting unit 402 may further divide the left-right area into a plurality of divided areas, and may set the divided area estimated to include the light source to a partial area, based on the pixel values of the respective divided areas. The division of such an area can be performed in a similar manner as illustrated in FIG. 7, for example. In that case, the setting unit 402 is capable of referring to the pixel value for each of the divided areas obtained by dividing the left-right area, and is capable of setting one or a plurality of the divided areas to the partial area(s). For example, the setting unit 402 may calculate the average (or the maximum value or the like) of the luminance for every divided area, and may set the partial area, based on a change amount of the average value of the luminance in the captured image captured during a predetermined period of time. For example, the setting unit 402 may set a divided area having a largest variance (or center of gravity) of the average value of the luminance during a predetermined period of time to a partial area, may set a divided area having such a variance equal to or larger than a threshold to be the partial area, or may set the partial area in accordance with a determination criterion different from them. In a similar manner to the example of FIG. 7, here the description has been given assuming that the luminance is referred to. However, in consideration that the amount of change in red would increase when the brake lamp is turned on, the R value may be used instead of the luminance, or a value obtained by performing a weighted sum of RGB such that the weight of the R value is larger than the luminance may be used.

Note that after the partial area is set in the above-described processing or after the divided area where the light source is located is set, a known tracking technique enables tracking of such an area. Here, it is assumed that tracking is performed by use of a learned tracking device to track the area including such a light source, and a detailed description is not given here.

### Summary of Embodiments

The above embodiments disclose at least an information processing apparatus, an information processing method, and a program in the following.
1. An information processing apparatus (110) according to the above-described embodiment comprises:
an obtaining unit configured to obtain a first image in which an advancing direction of a vehicle is captured and a second image in which the advancing direction of the vehicle is captured at a time different from a time when the first image is captured;
a setting unit configured to set a partial area including a light source provided in a preceding vehicle that precedes the vehicle in an image in which the advancing direction of the vehicle is captured, based on the first image and the second image;
an evaluating unit configured to evaluate periodicity of light emission of the light source, based on the partial areas in a plurality of images in which the advancing direction of the vehicle is captured; and
an identifying unit configured to identify a type of the light source, based on the periodicity.

According to this embodiment, the light of the preceding vehicle in the image can be determined in a more simplified manner.
2. In the information processing apparatus according to the above-described embodiment,
the evaluating unit evaluates whether the light source is blinking at a predetermined cycle, as the periodicity, and
the identifying unit identifies the type in accordance with evaluation of whether the light source is blinking at the predetermined cycle.

According to this embodiment, the light source that blinks at the predetermined cycle can be determined.
3. In the information processing apparatus according to the above-described embodiment,
   in a case where the light source is evaluated to blink at the predetermined cycle, the identifying unit identifies the light source as a blinker.

According to this embodiment, the light source that blinks at the predetermined cycle can be identified as a blinker.
4. In the information processing apparatus according to the above-described embodiment,
in a case where the light source is evaluated not to be blinking at the predetermined cycle, the identifying unit further evaluates whether the light source is turned on, and
in a case where the light source is evaluated to be turned on, the identifying unit identifies the light source as a brake lamp.

According to this embodiment, the light source that is turned on can be identified as a brake lamp.
5. In the information processing apparatus according to the above-described embodiment,
the identifying unit evaluates whether the light source is turned on, by using a part of an area obtained by dividing the partial area.

According to this embodiment, a processing load can be reduced.
6. In the information processing apparatus according to the above-described embodiment, wherein the identifying unit uses an area equal to or smaller than a predetermined y-coordinate in the image in which the advancing direction of the vehicle is captured, as the part of the area obtained by dividing the partial area.

According to this embodiment, the processing for an area where the brake lamp would not be present can be omitted.
7. In the information processing apparatus according to the above-described embodiment, wherein a time difference in capturing images between the first image and the second image is set, based on the periodicity of the light emission of the light source provided in the preceding vehicle.

According to this embodiment, an area where the light source is present can be searched for by use of images captured at intervals corresponding to assumed periodicity of the light emission of the light source.
8. In the information processing apparatus according to the above-described embodiment, wherein the evaluating unit evaluates the periodicity, based on a change in a pixel value of the partial areas in the plurality of images.

According to this embodiment, the periodicity of the light emission can be evaluated, based on a history of pixel values in an area including the light source.
9. In the information processing apparatus according to the above-described embodiment, wherein the evaluating unit evaluates the periodicity, by converting a pixel value of the partial areas in the plurality of images into a frequency domain.

According to this embodiment, the periodicity of the light emission can be evaluated in accordance with Fourier transform.
10. In the information processing apparatus according to the above-described embodiment, wherein the setting unit sets the partial area, based on a difference between the first image and the second image.

According to this embodiment, the light source can be searched for in an area where there is a change in pixel value.
11. In the information processing apparatus according to the above-described embodiment, wherein the setting unit sets the partial area to be included in an area having a predetermined width from either a right end or a left end of the image in which the advancing direction of the vehicle is captured.

According to this embodiment, the light source can be searched for in an area where the light source would be present.
12. In the information processing apparatus according to the above-described embodiment, wherein driving assistance of the vehicle is controlled in accordance with the type of the light source that has been identified.

According to this embodiment, the driving assistance can be performed in accordance with the type of light source that emits light.
13. An information processing method performed by an information processing apparatus (110) according to the above-described embodiment comprises:
obtaining a first image in which an advancing direction of a vehicle is captured and a second image in which the advancing direction of the vehicle is captured at a time different from a time when the first image is captured;
setting a partial area including a light source provided in a preceding vehicle that precedes the vehicle in an image in which the advancing direction of the vehicle is captured, based on the first image and the second image;
evaluating periodicity of light emission of the light source, based on the partial areas in a plurality of images in which the advancing direction of the vehicle is captured; and
identifying a type of the light source, based on the periodicity.

According to this embodiment, the light of the preceding vehicle in the image can be determined in a more simplified manner.
14. A non-transitory computer-readable storage medium, according to the above-described embodiment, storing a program that, when executed by a computer, causes the computer to perform an information processing method comprises:
obtaining a first image in which an advancing direction of a vehicle is captured and a second image in which the advancing direction of the vehicle is captured at a time different from a time when the first image is captured;
setting a partial area including a light source provided in a preceding vehicle that precedes the vehicle in an image in which the advancing direction of the vehicle is captured, based on the first image and the second image;
evaluating periodicity of light emission of the light source, based on the partial areas in a plurality of images in which the advancing direction of the vehicle is captured; and
identifying a type of the light source, based on the periodicity.

According to this embodiment, the light of the preceding vehicle in the image can be determined in a more simplified manner.

The invention is not limited to the foregoing embodiments, and various variations/changes are possible within the spirit of the invention.

What is claimed is:

1. An information processing apparatus comprising:
an obtaining unit configured to obtain a first image in which an advancing direction of a vehicle is captured and a second image in which the advancing direction of the vehicle is captured at a time different from a time when the first image is captured;
a setting unit configured to set a partial area including a light source provided in a preceding vehicle that precedes the vehicle in an image in which the advancing direction of the vehicle is captured, based on the first image and the second image;
an evaluating unit configured to evaluate periodicity of light emission of the light source, based on the partial areas in a plurality of images in which the advancing direction of the vehicle is captured; and
an identifying unit configured to identify a type of the light source, based on the periodicity.

2. The information processing apparatus according to claim 1, wherein
the evaluating unit evaluates whether the light source is blinking at a predetermined cycle, as the periodicity, and
the identifying unit identifies the type in accordance with evaluation of whether the light source is blinking at the predetermined cycle.

3. The information processing apparatus according to claim 2, wherein in a case where the light source is evaluated to blink at the predetermined cycle, the identifying unit identifies the light source as a blinker.

4. The information processing apparatus according to claim 2, wherein
in a case where the light source is evaluated not to be blinking at the predetermined cycle, the identifying unit further evaluates whether the light source is turned on, and
in a case where the light source is evaluated to be turned on, the identifying unit identifies the light source as a brake lamp.

5. The information processing apparatus according to claim 4, wherein the identifying unit evaluates whether the light source is turned on, by using a part of an area obtained by dividing the partial area.

6. The information processing apparatus according to claim 5, wherein the identifying unit uses an area equal to or smaller than a predetermined y-coordinate in the image in which the advancing direction of the vehicle is captured, as the part of the area obtained by dividing the partial area.

7. The information processing apparatus according to claim 1, wherein a time difference in capturing images between the first image and the second image is set, based on the periodicity of the light emission of the light source provided in the preceding vehicle.

8. The information processing apparatus according to claim 1, wherein the evaluating unit evaluates the periodicity, based on a change in a pixel value of the partial areas in the plurality of images.

9. The information processing apparatus according to claim 2, wherein the evaluating unit evaluates the periodicity, by converting a pixel value of the partial areas in the plurality of images into a frequency domain.

10. The information processing apparatus according to claim 1, wherein the setting unit sets the partial area, based on a difference between the first image and the second image.

11. The information processing apparatus according to claim 10, wherein the setting unit sets the partial area to be included in an area having a predetermined width from either a right end or a left end of the image in which the advancing direction of the vehicle is captured.

12. The information processing apparatus according to claim 1, wherein driving assistance of the vehicle is controlled in accordance with the type of the light source that has been identified.

13. An information processing method comprising:
obtaining a first image in which an advancing direction of a vehicle is captured and a second image in which the advancing direction of the vehicle is captured at a time different from a time when the first image is captured;
setting a partial area including a light source provided in a preceding vehicle that precedes the vehicle in an image in which the advancing direction of the vehicle is captured, based on the first image and the second image;
evaluating periodicity of light emission of the light source, based on the partial areas in a plurality of images in which the advancing direction of the vehicle is captured; and
identifying a type of the light source, based on the periodicity.

14. A non-transitory computer-readable storage medium storing a program that, when executed by a computer, causes the computer to perform an information processing method comprising:
obtaining a first image in which an advancing direction of a vehicle is captured and a second image in which the advancing direction of the vehicle is captured at a time different from a time when the first image is captured;
setting a partial area including a light source provided in a preceding vehicle that precedes the vehicle in an image in which the advancing direction of the vehicle is captured, based on the first image and the second image;
evaluating periodicity of light emission of the light source, based on the partial areas in a plurality of images in which the advancing direction of the vehicle is captured; and
identifying a type of the light source, based on the periodicity.
